(19) United States
(12) Patent Application Publication
(10) Pub. No.: US 2005/0109567 A1
(43) Pub. Date: May 26, 2005

(54) Electromechanical friction brake

(76) Inventors: Dietmar Baumann, Hemmingen (DE); Dirk Hofmann, Ludwigsburg (DE); Herbert Vollert, Vaihingen/Enz (DE); Willi Nagel, Remseck/Hochdorf (DE); Andreas Henke, Diemelstadt (DE); Bertram Foitzik, Ludwigsburg (DE); Bernd Goetzelmann, Moeglingen (DE)

Correspondence Address: RONALD E. GREIGG;GREIGG & GREIGG P.L.L.C., Suite One, 1423 Powhatan Street, Alexandria, VA, 22314, US

(21) Appl. No.: 10/969,926

(22) Filed: Oct. 22, 2004

(30) Foreign Application Priority Data
Oct. 22, 2003 (DE) 1 03 49 078.7

(51) Int. Cl. F16D 55/16; F16H 47/08

(52) U.S. Cl. 188/72.8

(57) ABSTRACT

The invention relates to an electromechanical friction brake having an electromechanical actuating device including an electric motor and a toothed gear assembly with which a friction brake lining can be pressed against a brake body for braking. Gear wheels of the assembly have sets of helical teeth braced with rotary bearings against the resultant axial forces. Sets of helical teeth have the advantage of better synchronism and of being capable of transmitting greater torque. Moreover, if the friction brake is used as a parking brake, an axial force effected by the set of helical teeth prevents occurrences of microscopic slippage in a locking device with a clamping action and thus prevents unintended automatic release of the locking device.

### BACKGROUND OF THE INVENTION

1. Field of the Invention

The invention relates to an improved electromechanical friction brake.

2. Description of the Prior Art

Electromechanical friction brakes are known per se. Typically, they are embodied as disk brakes, but they are not in principle limited to that form of brakes. They have a friction brake lining, which for braking can be pressed by an electromechanical actuating device against a brake body to be braked. In a disk brake, the brake body is a brake disk; in a drum brake, for instance, the brake body is a brake drum. The electromechanical actuating device of known electromechanical friction brakes has an electric motor and a toothed gear, which can be driven by the electric motor, for pressing the friction brake against the brake body. One example of such an electromechanical friction brake is disclosed by German Patent Disclosure DE 199 45 543 A1.

Such electromechanical friction brakes with self-boosting are also known. They typically additionally have a wedge mechanism to attain the self-boosting. The friction brake lining is movable in the direction of rotation of the brake disk and has a wedge on its back side, remote from the brake disk, that is braced on an abutment extending obliquely at a wedge angle to the brake disk. If upon braking the friction brake lining is pressed against the rotating brake disk, the brake disk exerts a frictional force on the friction brake lining that urges the friction brake lining in the direction of an increasingly narrower wedge gap between the abutment and the brake disk. The bracing of the friction brake lining on the abutment via the wedge creates a wedge force with a force component transverse to the brake disk. This force component forms a contact-pressure force, which is exerted by the wedge mechanism in addition to a contact-pressure force exerted by the actuating device. The self-boosting is attained in this way. One example of such a friction brake is disclosed by German Patent Disclosure DE 102 01 555 A1.

The toothed gear of the actuation units in the friction brakes have straight-toothed gear wheels and as a result prevent axial forces on rotary bearings of the toothed gears.

### OBJECT AND SUMMARY OF THE INVENTION

In the electromechanical friction brake of the invention, all or at least some of the gear wheels of the toothed gear of the actuation unit have a set of helical teeth. Especially upon actuation, that is, upon pressing of the friction brake lining against the brake body, the sets of helical teeth exert axial forces on the gear wheels, which according to the invention are intercepted by rotary bearings of the helical-toothed gear wheels that axially brace the helical-toothed gear wheels. The rotary bearings brace the helical-toothed gear wheels in at least one axial direction against the axial forces effected by the sets of helical teeth upon actuation of the friction brake. It is not necessary to use purely axial bearings as the rotary bearings; radial bearings for instance also suffice, which because of their construction are also capable of transmitting an axial force in at least one axial direction. Thus conventional radial ball bearings or radial roller bearings may be used, the latter only if they are capable of transmitting an axial force. In addition, oblique ball bearings and conical roller bearings can also be considered for the rotary bearing of the helical-toothed gear wheels.

The rotary bearing of the invention of the gear wheels of the toothed gear of the actuation unit of the friction brake makes it possible to use helical-toothed gear wheels. In comparison with straight-toothed gear wheels, helical-toothed gear wheels have the advantage that because of their greater degree of overlap, they run more quietly than straight-toothed gear wheels. The torque to be transmitted is modulated less by helical-toothed gear stages; that is, fluctuations in torque are reduced. This modulation is impressed on a motor current of the electric motor of the actuation unit and makes it more difficult, in straight-toothed gear wheels, later to ascertain a contact-pressure force of the friction brake against the brake body by measuring the motor current. Moreover, helical-toothed gear wheels are suitable for higher rotary speeds; for the same dimensions, they can transmit greater torques and are less vulnerable to tooth shape errors.

A further, major advantage of the invention is increased security against unintended, automatic release of a locking device of the friction brake, especially if the locking device cooperates by frictional engagement with a shiftable clamping overrunning clutch, for instance. By means of such a locking device, the friction brake of the invention, initially a service brake, is further refined so that it becomes a parking brake. For locking the friction brake, the friction brake is actuated, and the clamping overrunning clutch is shifted into a shifted position in which it allows a rotation or other motion of the actuation unit in only one actuation direction and blocks it against rotation or other motion in the release direction. The electric motor of the actuation unit is switched off; the actuated friction brake relaxes somewhat as a result and in the process rotates the clamping overrunning clutch a short distance in the blocking direction, until the overrunning clutch blocks. The friction brake maintains this actuated state when without current. For release, the overrunning clutch must be rotated a short distance again in the actuation direction of the friction brake and either be shifted into a basic position, or else it reaches its basic position on its own. In the basic position, a shaft of the shiftable clamping overrunning clutch is freely rotatable in both directions. In the parking brake position, the clamping overrunning clutch is retained as a result of a tensing of the actuated friction brake.

The tensing of the friction brake, via the set of helical teeth of the gear wheel of the shaft of the clamping overrunning clutch, exerts an axial force that is braced by the rotary bearing of the shaft of the clamping overrunning clutch. The axial force in the shifted, or in other words blocking, clamping overrunning clutch when the friction brake is actuated always acts in the same direction. This is also true for the shafts of the toothed gear of the actuation unit of the friction brake, as long as the shafts have helical-toothed gear wheels. The axial force assures that the shafts are axially without play as long as a contrary force does not exceed the axial force at the time. An axial motion of the shaft of the clamping overrunning clutch in the tensed state is avoided as a result, even if the magnitude of the axial force may vary because of a vibrational stress. In this way, so-called microscopic slippage caused by an axial motion of the shaft of the clamping overrunning clutch, which can lead to sagging of the shaft of the clamping overrunning clutch in small increments and can thus finally release the clamping overrunning clutch after some time, are averted by the invention. Because of the danger of the release of the clamping overrunning clutch, a set of helical teeth of the gear wheel of the shaft of the clamping overrunning clutch appears more important than at the other sets of teeth of the toothed gear of the actuation unit of the friction brake.

One embodiment provides that a gear wheel of a shaft of the clamping overrunning clutch be embodied with a set of helical teeth; that the clamping overrunning clutch be braced axially by a rotary bearing against the axial force caused by the set of helical teeth upon actuation of the friction brake; and that the rotary bearing be disposed near the clamping overrunning clutch. The phrase “near the clamping overrunning clutch” means that the rotary bearing is disposed not on a side of the electric motor of the actuation unit remote from the clamping overrunning clutch, for instance, but rather that the rotary bearing of the shaft of the clamping overrunning clutch is disposed for instance between the electric motor and the clamping overrunning clutch, or on a side of the clamping overrunning clutch remote from the electric motor and near the clamping overrunning clutch. As a result, a relative motion in the axial direction between the shaft and clamping bodies of the actuated clamping overrunning clutch, or between the clamping bodies and a housing of the clamping overrunning clutch, for instance as a consequence of temperature changes, is avoided or at least kept slight. This feature of the invention also counteracts microscopic slippage of the shaft in the clamping overrunning clutch.

Another feature provides a common housing of the rotary bearing of the shaft of the clamping overrunning clutch and of the clamping overrunning clutch itself; the housing has approximately the same temperature expansion as the shaft. This latter feature can be attained by using the same material for both the housing and the shaft. As a result, a relative motion of the shaft of the clamping overrunning clutch in the clamping overrunning clutch in the axial direction upon a temperature change is avoided. This accordingly prevents the occurrences of microscopic slippage of the shaft in the clamping overrunning clutch mentioned in the previous paragraph, which can release the clamping overrunning clutch.

The friction brake may have only one actuation direction, as is the case with electromechanical friction brakes without self-boosting or with self-boosting in only one direction of rotation of the brake body. In that case, the helical-toothed gear wheels exert an axial force always in the same axial direction; in the opposite direction, at most comparatively low axial forces arise. Axial bracing of the helical-toothed gear wheels by their rotary bearings in one axial direction is therefore sufficient.

If axial forces in both directions of rotation can occur, claim 6 provides axial bracing of the helical-toothed gear wheels in both axial directions. Axial forces in both directions of rotation occur for instance in electromechanical friction brakes that have self-boosting in both directions of rotation of the brake body, if the positioning of the friction brake lining is done as a function of the direction of rotation. For self-boosting in both directions of rotation, double wedges or oblique wedges opposite one another on the back side of the friction brake lining, remote from the brake disk, are known.

In an embodiment will two coaxial and fixedly, in other words immovably, joined-together helical-toothed gear wheels, their sets of teeth may have obliquities in the same direction; the angle of obliquity may be quantitatively the same, or different. Such gear wheels, typically on a common shaft, are used to achieve multi-stage toothed gears. The obliquities in the same direction effect an at least partial compensation for the axial forces of a driving gear wheel and a driven helical-toothed gear wheel.

### BRIEF DESCRIPTION OF THE DRAWINGS

The invention will be better understood and further objects and advantages thereof will become more apparent from the ensuing detailed description, taken in conjunction with the drawings, in which:

FIG. 1 shows an actuation unit of an electromechanical friction brake of the invention;

FIG. 2 is a cross section through a clamping overrunning clutch of the friction brake taken along the line II-II in FIG. 1, in a basic position of the clamping overrunning clutch; and

FIG. 3 shows the clamping overrunning clutch of FIG. 2 in a shifted position.

### DESCRIPTION OF THE PREFERRED EMBODIMENT

The drawing is understood to be a schematic, simplified illustration. The electromechanical friction brake 10 of the invention, shown in the drawing, is embodied as a disk brake. It has a friction brake lining 12, which for braking can be pressed by an electromechanical actuation unit 14 against a brake disk 16, which forms a brake body. The electromechanical actuation unit 14 has a three-stage toothed gear assembly 18 (hereinafter, toothed gear 18) and an electric motor 20, of which, for the sake of clear illustration, only an armature 22 (rotor) and a motor shaft 24 are shown. A shiftable clamping overrunning clutch 26 is also provided, with which the friction brake 10 can be locked in the actuated position. The clamping overrunning clutch 26 forms a locking device, with which the friction brake 10 is further developed into a parking brake. It is not compulsory that the clamping overrunning clutch 26 be disposed on the motor shaft 24; it may instead be provided on some other gear shaft of the toothed gear 18, for example.

The motor shaft 24 of the electric motor 22 is provided, for instance by means of a metal-cutting process, with a set of teeth that forms a first gear wheel 30 of the toothed gear 18. The first gear wheel 30 meshes with a second, larger-diameter gear wheel 32, which is solidly (rigidly) joined to a third gear wheel 34. The gear wheel 34 is coaxial with the second gear wheel 32 and has a smaller diameter than the second gear wheel 32.

The third gear wheel 34 meshes with a fourth gear wheel 36, which has a larger diameter than the third gear wheel 34. The fourth gear wheel 36 is solidly joined to a fifth gear wheel 38, which has a smaller diameter than the fourth gear wheel 36. The fifth gear wheel 38 meshes with a curved rack 40, whose course will be explained in further detail hereinafter. The rack 40 is integral with a brake lining mounting 42, on whose side toward the brake disk 16 the friction brake lining 12 is mounted. The brake lining mounting 42 is pivotable about an axis of rotation, not shown, of the brake disk 16 and is also movable in the direction of the brake disk 16, that is, axially to it.

A second friction brake lining, not shown, is disposed on an opposite side of the brake disk 16; in a manner known per se, it rests in a brake caliper, also not shown, that is embodied as a floating caliper or in other words is displaceable transversely to the brake disk 16. If the friction brake lining 12 shown is pressed for braking against the brake disk 16, the effect in a manner known per se is a transverse displacement of the caliper, which as a result presses the friction brake lining not shown against the other side of the brake disk 16, so that the brake disk 16 is braked.

The first and second gear wheels 30, 32; the third and fourth gear wheels 34, 36; and the fifth gear wheel 38 and the rack 40 each form one gear stage of the toothed gear 18. All the gear wheels 30, 32, 34, 36, 38 and the rack 40 have a set of helical teeth. The motor shaft 24 and the first gear wheel 30 form a first gear shaft of the toothed gear 18. The motor shaft 24 is rotatably supported, on an end remote from the electric motor 20, by a radial ball bearing 44. The ball bearing 44 is also capable of transmitting axial forces; thus it forms a rotary bearing, which braces the motor shaft 24 and thus the first gear wheel 30 against an axial force effected by the set of helical teeth. Bracing in one axial direction suffices, since an actuation of the friction brake 10 is always effected in the same direction, that is, in a direction of rotation of the electric motor 20, and therefore the axial force effected by the set of helical teeth (including upon release of the friction brake 10) acts in the same axial direction. If nevertheless an axial force should act in the opposite direction, then a journal 46, represented by dashed lines in the drawing, may be provided on one face end of the motor shaft 24 and braces the motor shaft 24 in that case. If high axial forces can also occur in the opposite direction, then the ball bearing 44 should be embodied as a fixed bearing, which axially braces the motor shaft 24 in both directions.

On the other end, remote from the first gear wheel 30, the motor shaft 24 is supported by a needle bearing 48. The needle bearing 48 forms a radial bearing, which does not axially brace the motor shaft 24.

The second and third gear wheels 32, 34 are mounted in a manner fixed against relative rotation on a second gear shaft 50, which like the motor shaft 24 is supported by a radial ball bearing 52 on one end and by a needle bearing 54 on the other end. The ball bearing 52, which can also transmit axial forces, is embodied as a fixed bearing; that is, it is axially fixed in both directions by a securing ring 54 (Seeger circlip ring), which is inserted into a groove extending all the way around in the gear shaft 50, and by a housing cap 56. The ball bearing 52 thus forms a rotary bearing for the gear wheels 32, 34 that braces them axially in both directions. If an axial force can occur in only one direction, then a simplified version suffices, with a rotary bearing that braces in only one axial direction, for instance without the securing ring 54 (this option is not shown).

Like the second and third gear wheels 32, 34, the fourth and fifth gear wheels 36, 38 are also mounted in a manner fixed against relative rotation on a third gear shaft 58, which is likewise rotatably supported by a radial ball bearing 60, embodied as a fixed bearing, on one end, and by a needle bearing 62 on the other end. Once again, the ball bearing 60 forms a rotary bearing, which axially braces the gear shaft 58 in both directions, or in a simplified version in one direction. For bracing the gear shafts 50, 58 in the opposite axial direction, journals 64, 66 indicated by dashed lines in the drawings may be provided on face ends of the gear shafts 50, 58.

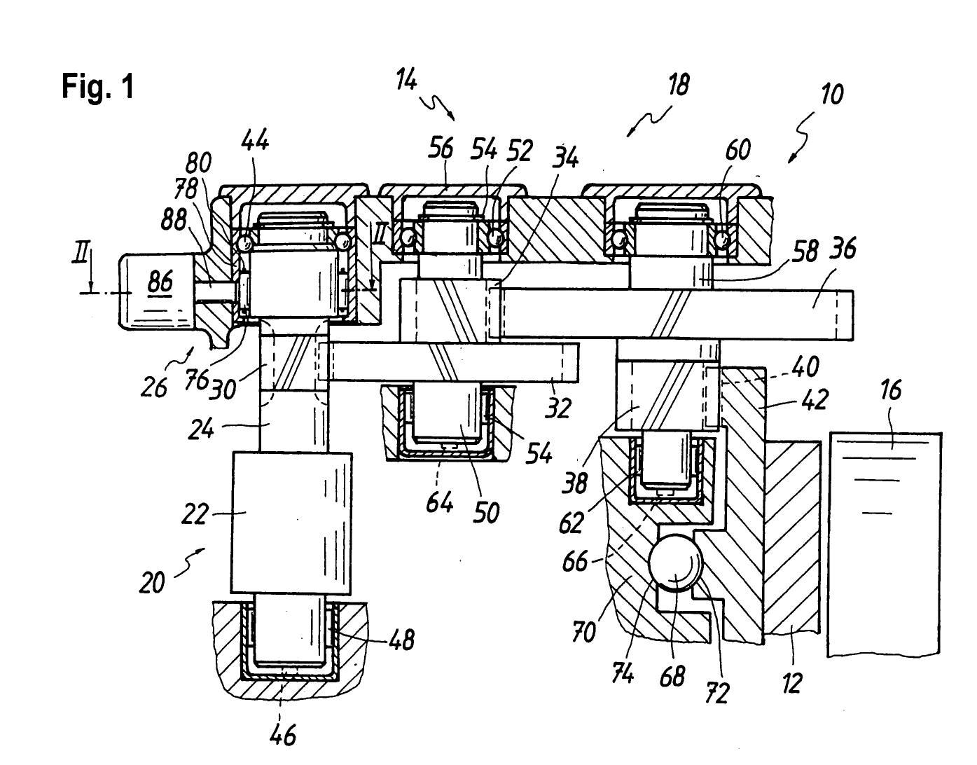

For actuating the disk brake 10, the electric motor 20 is driven in one actuation direction by being supplied with current. Via the toothed gear 18, the brake lining mounting 42, which is pivotable about the imaginary axis of rotation of the brake disk 16, is pivoted. Transversely to the brake disk 16, the brake lining mounting 42 is braced on abutments 70, via balls 68 that are disposed on a back side of the brake lining mounting 42, away from the brake disk 16. The balls 68, only one of which is visible in FIG. 1, rest in channels 72, 74 that are made in the brake lining mounting 42 and in the abutment 70. The channels 72, 74 extend along an imaginary circular arc around the axis of rotation of the brake disk 16; the channels 72 in the brake lining mounting 42 extend in the opposite direction from the channels 74 in the abutment 70. A depth of the channels 72 in the brake lining mounting 42 also decreases in the opposite direction from a depth of the channels 74 in the abutment 70. Pivoting of the brake lining mounting 42 upon actuation of the disk brake 10 causes the balls 68 to roll in the channels 72, 74 and, since the depth of the channels 72, 74 decreases, to press the brake lining mounting 42 with the friction brake lining 12 against the brake disk 16. The brake disk 16 is braked as a result. Because of their decreasing depth, the channels 72, 74 form wedge or ramp faces, which could also be called keyways or rampways.

If the brake disk 16 rotates in the pivoting direction of the brake lining mounting 42, it exerts a frictional force on the friction brake lining 12 pressed against it, and this force urges the friction brake lining mounting 42 in its pivoting direction. The channels 72, 74 extending obliquely at an angle to the brake disk 16, because of this imposition of friction and on the principle of a wedge, exert a force transverse to the brake disk 16, and this force additionally presses the friction brake lining 12 against the brake disk 16. As a result, a braking force exerted by the actuation unit 14 is boosted.

As already described above, the rack 40 extends along an imaginary circular arc around the imaginary axis of rotation of the brake disk 16 about which the brake lining mounting 42 is pivotable. At the same time, the rack 40 extends obliquely at an angle, transversely to the brake disk 16, in order to compensate for the motion of the brake lining mounting 42 transversely to the brake disk 16 upon actuation of the friction brake 10. In other words, the rack 40 extends in a helical line.

To compensate partially or entirely for the axial forces caused by the sets of helical teeth, the sets of helical teeth of the gear wheels 32, 34; 36, 38 that are solidly joined to one another have obliquities in the same direction, as is shown in the drawing. It is therefore possible under some circumstances to dispense with a rotary bearing that axially braces the gear shafts 50, 58 (this option is not shown).

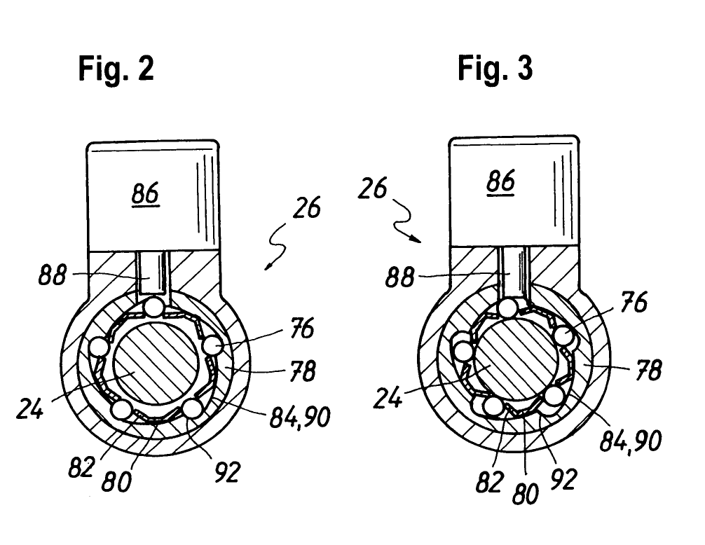

The clamping overrunning clutch 26, shown in FIG. 2, of the friction brake 10 has rollers 76 as its clamping bodies, which are disposed between the motor shaft 24 and a fixed sleeve 78 that is coaxial to the motor shaft 24. The rollers 76 are kept equidistant by a roller cage 80. The roller cage 80 has spring tongues 82, which press the rollers 76 outward against the sleeve 78. The sleeve 78 has wedge-shaped pockets 84, into which the rollers 76 are pressed by the spring tongues 82. FIG. 2 shows a basic position of the overrunning clutch 26, in which the motor shaft 24 is freely rotatable in both directions. The clamping overrunning clutch 26 is shiftable by means of a monostable electromagnet 86. Via a tappet 88, the electromagnet 86, when it is supplied with current, presses one of the rollers 76 radially inward against the motor shaft 24. This is the so-called shifted position of the clamping overrunning clutch 26 that is shown in FIG. 3. If the motor shaft 24 in FIG. 3 is rotated counterclockwise, then the roller 76 pressed against the motor shaft 24 by the tappet 88 rolls in the sleeve 78. Via the roller cage 80, this roller 76 carries the other rollers 76 along with it in the circumferential direction. The rollers 76 as a result roll in the wedge-shaped pockets 84 of the sleeve 78; in the process, they are pressed radially inward by wedge faces 90 of the pockets 84 against the motor shaft 24 and firmly clamp it. The motor shaft 24 can therefore rotate only a short distance in this direction of rotation, which is the blocking direction. In the reverse direction of rotation of the motor shaft 24, that is, clockwise in FIG. 3, the rollers 76 abut against ends 92 of the pockets 84; they are pressed outward by the spring tongues 82 of the roller cage 80 and do not abut against the motor shaft 24. In this direction of rotation, the motor shaft 24 is accordingly freely rotatable in the shifted position of the clamping overrunning clutch 26 as well. The clamping overrunning clutch 26 is disposed such that its freewheeling direction in the shifted position corresponds to the actuation direction of the friction brake 10, and that the blocking direction of the overrunning clutch 26 corresponds to a release direction of the friction brake 10.

For locking the friction brake 10, the friction brake is actuated as described above by means of supplying current to the electric motor 20, and as a result the friction brake lining 12 is pressed against the brake disk 16. Supplying current to the electromagnet 86 shifts the clamping overrunning clutch 26 into the shifted position. Next, the supply of current to the electric motor 20 is turned off. Since the friction brake 10 is under mechanical tension, a reverse torque arises that rotates the motor shaft 24 in the release direction. Because the overrunning clutch 26 is in the shifted position, the motor shaft 24 can be rotated only a short distance and is then blocked against further rotation by the clamping overrunning clutch 26, as described above. The supply of current to the electromagnet 86 can also be shut off; the prestressing of the actuated disk brake 10 keeps the clamping overrunning clutch 26 in the blocking position. The disk brake 10 is locked in the actuated position (parking brake function). By supplying current to the electric motor 20 in the actuation direction, the overrunning clutch 26 and after it the friction brake 10 can be released.

Because the ball bearing 44 that axially braces the motor shaft 24 is disposed axially immediately adjacent the clamping overrunning clutch 26 that forms the locking device of the disk brake 10, relative motions of the motor shaft 24 with respect to the rollers 76 and the sleeve 78 of the clamping overrunning clutch 26 in the axial direction from temperature expansions are prevented. As a result, occurrences of microscopic slippage, which could unintentionally release the clamping overrunning clutch 26, between the motor shaft 24, the rollers 76, and the sleeve 78 of the clamping overrunning clutch 26 are avoided. The set of helical teeth of the first gear wheel 30, which because of the mechanical prestressing of the actuated friction brake 10 exerts an axial force in one axial direction, also prevents axial relative motions between the motor shaft 24, the rollers 76 and the sleeve 78 of the clamping overrunning clutch 26 and thus prevents the aforementioned occurrences of microscopic slippage that could unintentionally release the blocked clamping overrunning clutch 26.

The sleeve 78 of the clamping overrunning clutch 26 simultaneously forms an outer ring of the ball bearing 44 of the motor shaft 24 of the electric motor 20, which shaft is at the same time also the shaft of the clamping overrunning clutch 26. The sleeve 78 is of the same material as the motor shaft 24 and accordingly has the same coefficients of temperature expansion. As a result, an axial motion of the motor shaft 24, which is simultaneously the shaft of the clamping overrunning clutch 26, in the sleeve 78 of the clamping overrunning clutch 26 upon a temperature change is avoided. This too is a provision for preventing the occurrences of microscopic slippage of the motor shaft 24 or in other words the shaft of the clamping overrunning clutch 26 that can release the blocked clamping overrunning clutch 26. The sleeve 78 of the clamping overrunning clutch 26 that simultaneously forms the outer ring of the ball bearing 44 of the motor shaft can also be conceived of as a common housing of both the clamping overrunning clutch 26 and the ball bearing 44.

The foregoing relates to a preferred exemplary embodiment of the invention, it being understood that other variants and embodiments thereof are possible within the spirit and scope of the invention, the latter being defined by the appended claims.

1. An electromechanical friction brake, comprising
an electromechanical actuation unit, with which a friction brake lining can be pressed for braking against a brake body to be braked,
the actuation unit having a toothed gear (18) including gear wheels (30, 32, 34, 36, 38, 40) having a set of helical teeth, and
rotary bearings (44, 52, 60) of the helical-toothed gear wheels (30, 32, 34, 36, 38) bracing the gear wheels axially in at least one axial direction against an axial force effected by the sets of helical teeth upon actuation of the friction brake (10).

2. The friction brake in accordance with claim 1, wherein the friction brake (10) further comprises a locking device (26), with which the friction brake (10) can be locked in the actuated state.

3. The friction brake in accordance with claim 2, wherein the locking device comprises a shiftable clamping overrunning clutch (26).

4. The friction brake in accordance with claim 3, wherein the clamping overrunning clutch (26) comprises a shaft (24) having a gear wheel (30) with a set of helical teeth, a rotary bearing (44) supporting the rotary shaft (24) and bracing the clamping overrunning clutch (26) axially in at least one axial direction against an axial force effected by the set of helical teeth upon actuation of the friction brake (10);
the rotary bearing (44) being disposed near the clamping overrunning clutch (26).

5. The friction brake in accordance with claim 4, wherein the clamping overrunning clutch (26) and the rotary bearing (44) of the shaft (24) of the clamping overrunning clutch (26) have a common housing (78); and wherein the housing (78) comprises a material which has approximately the same temperature expansion as the shaft (24) of the clamping overrunning clutch (26).

6. The friction brake in accordance with claim 1, wherein the friction brake (10) has only one actuation direction.

7. The friction brake in accordance with claim 1, wherein the rotary bearings (44, 52, 60) of the helical-toothed gear wheels (30, 32, 34, 36, 40) brace the gear wheels (30, 32, 34, 36, 38) axially in both axial directions.

8. The friction brake in accordance with claim 1, wherein the toothed gear (18) has multiple stages and has two coaxial, fixedly joined-together, helical-toothed gear wheels (32, 34; 36, 38), whose sets of teeth are helical in the same direction.
